(19) United States
(12) Patent Application Publication
(10) Pub. No.: US 2023/0073769 A1
(43) Pub. Date: Mar. 9, 2023

(54) Spatial Data Abrupt Change Inspection Method, Application System and Cloud Platform in National Territory Development Planning

(71) Applicants: Sichuan Forestry and Grassland Investigation and Planning Institute, Chengdu (CN); Sichuan Forestry Survey, Design and Research Institute Co., Ltd., Chengdu (CN); Kunming Survey and Design Institute of State Forestry Administration, Kunming (CN); Chengdu Academy of Agricultural and Forestry Sciences, Chengdu (CN)

(72) Inventors: Fei Gao, Chengdu (CN); Nana Li, Chengdu (CN); Chengcheng Zhang, Kunming (CN); Yongjun Wang, Chengdu (CN); Bei Huang, Kunming (CN); Hua Li, Kunming (CN); Xianpeng Xu, Kunming (CN)

(21) Appl. No.: 18/054,908

(22) Filed: Nov. 13, 2022

Related U.S. Application Data
(63) Continuation of application No. PCT/CN2021/113085, filed on Aug. 17, 2021.

(30) Foreign Application Priority Data
May 20, 2021 (CN) 202110549437.0

(51) Int. Cl. G06F 16/29; G06F 16/2458; G06F 16/23; H04L 9/06

(52) U.S. Cl. CPC G06F 16/29; G06F 16/2462; G06F 16/2365; H04L 9/0618

(57) ABSTRACT

A spatial data abrupt change inspection method in national territory development planning, an application system and a cloud platform are disclosed. The spatial data abrupt change inspection method in national territory development planning includes the steps of preprocessing of abrupt change inspection data and abrupt change inspection; the application system applies the spatial data abrupt change inspection method in national territory development planning to perform abrupt change inspection; and the cloud platform is configured with the application system. After preprocessing of a superior user, all comparison computing is based on comparison of attribute data. A spatial planning cloud support platform is used for computing in a distributed manner.

### CROSS REFERENCE TO RELATED APPLICATIONS

The present application is a Continuation Application of PCT Application No. PCT/CN2021/113085 filed on Aug. 17, 2021, which claims the benefit of Chinese Patent Application No. 202110549437.0 filed on May 20, 2021. All the above are hereby incorporated by reference in their entirety.

### TECHNICAL FIELD

The present disclosure belongs to the technical field of geospatial data computing, identification and processing, and in particular to a spatial data abrupt change inspection method in national territory development planning, an application system and a cloud platform.

### BACKGROUND

A service system of national territory development planning horizontally covers the departments of surveying and mapping, natural resources, development and reform, environmental protection, housing construction, transportation, water conservancy, agriculture, forestry and the like; and vertically runs through the five levels of the state, province, city, country and township. In the process of using the spatial data in national territory development planning, due to the wrong version control, wrong operation of data editing or malicious tampering by users, the same spatial data in national territory development planning at different levels or between different departments are often inconsistent in graphic shape, attribute information, the number of records, spatial coordinate system and other contents, which is called spatial data abrupt change in national territory development planning. Effectively performing spatial data abrupt change inspection in national territory planning and ensuring the consistency and accuracy of the data in national territory development planning of all departments at all levels are the premise for all departments at all levels to perform national territory development planning, and also an important basic work that runs through the early, middle and late stages of national territory development planning. The spatial data in national territory development planning in the present disclosure mainly refers to the results of the third national territory survey, the “one map” of forest resource management, the results of the national geographical survey, the red line of ecological protection, permanent basic farmland, urban development boundaries and other five levels of spatial vector layer data used synchronously at the state, province, city, country and township levels.

At present, the main data abrupt change inspection method used in national territory development planning is that a superior user performs spatial geographic processing with spatial vector layer results submitted by a subordinate user through a spatial vector layer mastered by the superior user, such as Union, Intersect, Symmetric Difference and other operations, so as to obtain a new spatial vector layer with attribute field information of the two spatial vector layers, and by comparing the number of pattern spots of the new spatial vector layer and the type and field value of the attribute fields with the same name before and after, it is determined whether the spatial vector layer submitted by the subordinate user has an abrupt change. However, this method mainly has the following disadvantages: first, the computing power consumption is large, it is necessary to perform graphic joint operation and computing to determine the change of graphics, while graphic comparison requires high computing power and is time-consuming; second, the timeliness is poor, the data cannot be inspected until the subordinate units have completed all the planning work and submitted the results, and if errors are found at this time, the entire work needs to be reworked; and third, the work is concentrated, a superior unit needs to perform graphic comparison and attribute comparison of data of each subordinate unit, when there are many subordinate units or many attribute fields, the work pressure of the superior unit is huge.

In view of the defects in spatial data abrupt change inspection in national territory development planning in the related art, it is urgent to provide a spatial data abrupt change inspection method in national territory development planning, an application system and a cloud platform that can achieve early detection of spatial data abrupt change in national territory development planning, fast computing, analysis and comparison and distributed management, and ensure the consistency and accuracy of data in national territory development planning of all departments at all levels.

### SUMMARY

An objective of the present disclosure is to provide a spatial data abrupt change inspection method in national territory development planning, an application system and a cloud platform that can achieve early detection of spatial data abrupt change in national territory development planning, fast computing, analysis and comparison and distributed management, and ensure the consistency and accuracy of data in national territory development planning of all departments at all levels.

The above objective is implemented through the following technical solutions: a spatial data abrupt change inspection method in national territory development planning, which includes the following steps:

(1) preprocessing of abrupt change inspection data: converting abrupt change control spatial data in national territory development planning of a superior user and to-be-compared spatial data in national territory development planning of a subordinate user from a spatial vector layer to an attribute database with unique identification information:

(1.1) adding five fields named ID, X, Y, shape eigenvalue and coordinate system description to an abrupt change control spatial vector layer in spatial data in national territory development planning of the superior user and a to-be-compared spatial vector layer in spatial data in national territory development planning of the subordinate user respectively, where a field type of the ID field is text, field types of the X field and the Y field are integer, a field type of the shape eigenvalue field is double precision, and a field type of the coordinate system description field is text;

(1.2) computing the X field as an abscissa value of centroid of each feature in the spatial vector layer, computing the Y field as an ordinate value of the centroid of each feature in the spatial vector layer, computing the shape eigenvalue field as a graphic related value of each feature in the spatial vector layer and computing the ID field as a combined character string of the X field, the Y field and the shape eigenvalue field connected by a connector, where the ID field is the unique identification information;

(1.3) computing coordinate system description fields of the abrupt change control spatial vector layer and the to-be-compared spatial vector layer as a spatial coordinate system name of the spatial vector layer;

(1.4) combining the ID field of the abrupt change control spatial vector layer with an attribute field that the superior user needs to control abrupt change to form an abrupt change control attribute database with the unique identification information; and combining the ID field of the to-be-compared spatial vector layer of the subordinate user with an attribute field that the subordinate user needs to request comparison to form a to-be-compared attribute database with the unique identification information; and

(2) abrupt change inspection: connecting the abrupt change control attribute database and the to-be-compared attribute database through the unique identification information, inspecting abrupt change records and abrupt change reasons through quantity statistics and attribute comparison, and summarizing into an abrupt change inspection result database:

(2.1) performing statistics on the number of records in the to-be-compared attribute database of the subordinate user;

(2.2) obtaining the abrupt change control attribute database of the superior user, performing statistics on the number of records in the abrupt change control attribute database, comparing the number of records in the to-be-compared attribute database with the number of records in the abrupt change control attribute database, determining whether comparison results are consistent, in response to determining that the comparison results are inconsistent, determining that the to-be-compared spatial data in national territory development planning of the subordinate user has an abrupt change, and the abrupt change reason is that “the number of pattern spots is inconsistent”, registering and summarizing the abrupt change reason into the abrupt change inspection result database; in response to determining that the comparison results are consistent, performing step (2.3);

(2.3) performing left association query on the abrupt change control attribute database and the to-be-compared attribute database by using the unique identification information ID field:

(2.3.1) determining whether all records in the abrupt change control attribute database have corresponding values in the to-be-compared attribute database, in response to determining that all records do not have corresponding values, determining that the to-be-compared spatial data in national territory development planning has an abrupt change, recording the abrupt change reason as “the ID fields do not correspond one to one”, and summarizing non-corresponding ID values of the abrupt change control attribute database and error reasons into the abrupt change inspection result database;

(2.3.2) reading the attribute field that the superior user needs to control abrupt change in the abrupt change control attribute database, searching a field with the same name in the to-be-compared attribute database, and reading the field type and the field value: determining whether the name of the attribute field that the superior user needs to control abrupt change in the abrupt change control attribute database is matched in the to-be-compared attribute database, in response to determining that the name is not matched, determining that the to-be-compared spatial data in national territory development planning has an abrupt change, recording the abrupt change reason as “a mandatory field name is absent”, and summarizing current ID values of the to-be-compared attribute database and error reasons into the abrupt change inspection result database;

(2.3.3) determining whether the field type of the attribute field that the superior user needs to control abrupt change in the abrupt change control attribute database is consistent with the field type of the same name field in the to-be-compared attribute database, in response to determining that the field types are inconsistent, determining that the to-be-compared spatial data in national territory development planning has an abrupt change, recording the abrupt change reason as “the mandatory factor field types are inconsistent”, and summarizing the current ID values of the to-be-compared attribute database and error reasons into the abrupt change inspection result database;

(2.3.4) determining whether the field precision of the attribute field that the superior user needs to control abrupt change in the abrupt change control attribute database is consistent with the field precision of the same name field in the to-be-compared attribute database; in response to determining that the field precision is inconsistent, determining that the spatial data of the to-be-compared spatial vector layer in national territory development planning has an abrupt change, recording the abrupt change reason as “the mandatory factor field precision is inconsistent”, and summarizing the current ID values of the to-be-compared attribute database and error reasons into the abrupt change inspection result database;

(2.3.5) determining whether the field value of the attribute field that the superior user needs to control abrupt change in the abrupt change control attribute database is consistent with the field value of the same name field in the to-be-compared attribute database; in response to determining that the field values are inconsistent, determining that the spatial data of the to-be-compared spatial vector layer in national territory development planning has an abrupt change, recording the abrupt change reason as “the mandatory factor field values are inconsistent”, and summarizing the current ID values of the to-be-compared attribute database and error reasons into the abrupt change inspection result database;

(2.4) reading and comparing a coordinate system description field value of the abrupt change control attribute database with a coordinate system description field value of the to-be-compared attribute database, determining whether the coordinate system description field value of the to-be-compared attribute database is consistent with the coordinate system description field value in the abrupt change control attribute database, in response to determining that the coordinate system description field values are inconsistent, determining that the to-be-compared spatial data in national territory development planning has an abrupt change, recording the abrupt change reason as “the coordinate system description information is inconsistent”, and registering and summarizing the abrupt change reason into the abrupt change inspection result database; and

(2.5) outputting records of the abrupt change inspection result database.

It needs to be noted that a feature in step 1.2 refers to a piece of information in the spatial vector layer, the information includes spatial information and attribute information, in addition, each spatial vector layer has a spatial coordinate system, and the spatial coordinate system is composed of a coordinate system name, a central longitude, a geographic coordinate system and the like; in step 1.3, the coordinate system name in the coordinate system is stored as a coordinate system description field for later comparison; and ID, X, Y, shape eigenvalue and coordinate system description fields added in step 1.4 are used for inspecting the changes of spatial data graphics, however, some attribute fields of the spatial data in national territory development planning also need to be controlled, which is determined by the specific situation. At this time, the attribute field that needs to control abrupt change is to be selected, and after the attribute field is selected together with the ID, X, Y, shape eigenvalue and coordinate system description fields, they jointly form an attribute database. A record in step 2.1 refers to a piece of information of the attribute database, which merely includes attribute information, does not include spatial information, so the record is different from the feature.

A further technical solution is that in step (1.2), types of the abrupt change control spatial vector layer and the to-be-compared spatial vector layer in the spatial data in national territory development planning are determined, in response to determining that the spatial vector layer is a plane layer, the shape eigenvalue field is computed as an area of a spatial vector layer feature, in response to determining that the spatial vector layer is a line layer, the shape eigenvalue field is computed as a length of the spatial vector layer feature, and in response to determining that the spatial vector layer is a point layer, the shape eigenvalue field is computed as a null value.

A further technical solution is that between step (1) and step (2), the method further includes a step of encrypting the abrupt change control attribute database:

S1 submitting an abrupt change inspection application by the subordinate user, and submitting a layer name of the to-be-compared spatial vector layer, a user name and user password ciphertext of the subordinate user as parameters to the superior user;

S2 performing, by the superior user, authentication on the application submitted by the subordinate user, using the user name and the user password ciphertext submitted by the subordinate user for searching and comparing in a user system of the superior user, and in response to determining that the authentication fails, ending directly;

S3 after the authentication is passed, obtaining, by the superior user, the abrupt change control attribute database with the same name as the to-be-compared spatial vector layer of the subordinate user in the abrupt change control attribute database;

S4 initializing a symmetric encryption object by the superior user using the user password ciphertext of the subordinate user;

S5 encrypting the obtained abrupt change control attribute database by the superior user using the encryption object;

S6 outputting the abrupt change control attribute database stored in ciphertext by the superior user;

S7 transmitting the abrupt change control attribute database stored in ciphertext to the subordinate user by the superior user;

S8 storing locally the abrupt change control attribute database stored in ciphertext obtained from the superior user by the subordinate user;

S9 reading the local user password ciphertext and initializing the symmetric encryption object by the subordinate user, an algorithm used for the encryption object being the same as S4 at this time;

S10 decrypting the obtained abrupt change control attribute database by using the encryption object; and

S11 obtaining and storing cleartext results of the abrupt change control attribute database.

The present disclosure further provides an application system, the application system is used for data processing by using the above spatial data abrupt change inspection method in national territory development planning, and includes a cloud client application system and a cloud server application system. The cloud client application system includes: a user login module, configured to register and login the cloud client application system by a user; a to-be-compared spatial vector layer import and preprocessing module, configured to import a local to-be-compared spatial vector layer by the user according to a spatial data list that needs to be used according to requirements of national territory development planning, complete preprocessing of the imported data after the import, and give an error prompt for the absent spatial data that has not been imported; a spatial data decrypting module, configured to decrypt the abrupt change control attribute database stored in ciphertext obtained by application using user password ciphertext as a private key, obtain and store cleartext results of the abrupt change control attribute database; a spatial data abrupt change inspection module, configured to compare a to-be-compared attribute database with the obtained abrupt change control attribute database for spatial graphics, attribute factors and coordinate systems, and inspect whether a to-be-compared spatial vector layer has an abrupt change condition; and a spatial data abrupt change inspection result export module, configured to export abrupt change inspection results by the user.

A further technical solution is that the spatial data abrupt change inspection module includes: a spatial graphic abrupt change inspection module, configured to inspect problems that the number of pattern spots and the graphics are inconsistent; an attribute data abrupt change inspection module, configured to inspect problems that names, types, precision and attribute values of attribute fields are inconsistent; and a coordinate system abrupt change inspection module, configured to inspect a problem that coordinate system description information is inconsistent.

A further technical solution is that the cloud server application system includes: a user login module, configured to register and login the cloud server application system by the user; an abrupt change control spatial vector layer import module, configured to import a local abrupt change control spatial vector layer of the user by the user according to a spatial data list that needs to control abrupt change according to requirements of national territory development planning; an abrupt change control attribute database generating module, configured to select an abrupt change control spatial vector layer and attribute fields that needs to control abrupt change in each abrupt change control spatial vector layer by the user, complete preprocessing of the imported data, and generate an abrupt change control attribute database; an abrupt change control attribute database encrypting module, configured to symmetrically encrypt content of the abrupt change control attribute database by using obtained user password ciphertext of the subordinate user as a private key in a case that an application for accessing and obtaining the abrupt change control attribute database is accepted, encrypt the abrupt change control attribute database into the abrupt change control attribute database stored in ciphertext, and then transmit; and a user management module, configured to store and manage user information including user names and passwords of a cloud application system and the cloud server application system, where the user password is stored in a form of ciphertext.

The present disclosure further provides a cloud platform system, which is configured with any of the above application systems, and includes: a cloud client, configured with a cloud client application system; a cloud server, configured with a cloud server application system to provide a data comparison service for the cloud client application system; and a cloud support platform, configured to provide computing, storage, network communication and system operation capability supports for the cloud client application system and the cloud server application system. A further technical solution is that the cloud client includes but is not limited to computing and storage terminals such as a PC machine, a mobile laptop and a graphic workstation configured with the cloud client application system.

A further technical solution is that the cloud support platform includes an X86 computing server for building a computing resource pool, a storage server for building a storage resource pool, a network server and gateway device for building a network resource pool, virtualization platform software for resource virtualization management, and one or more of application platforms that configure an operating system, a database platform, a GIS platform and network middleware on the platform.

Compared with the prior art, the present disclosure has the following advantages:

1. The timeliness is high. Since the data preprocessed by the superior user is stored in the cloud server application system of the cloud support platform, the comparison work can merely be proposed unilaterally by the cloud client of the subordinate user, without the manual participation of the superior user, and the cloud client may submit a comparison application at any time according to the needs, so as to ensure the accuracy of the use of the spatial data in national territory development planning at the beginning of the work, and the spatial data tampering caused by misoperation can be corrected at any time at the beginning of work.

2. The computing consumption is small, and the efficiency is high. After preprocessing by the superior user, all comparison computing is based on data comparison of the attribute database, SQL statements of a relational database are used for execution, and the efficiency is an order of magnitude improvement compared with that of the graphic computing.

3. The workload is decentralized. The centralized spatial comparison and attribute comparison work originally carried out by the superior user is computed in a distributed way by using the cloud client application system and the cloud server application system configured by the cloud support platform, the workload of the superior user accepting the comparison application is reduced, and the process and time for the subordinate user to submit for approval and comparison are shortened.

### BRIEF DESCRIPTION OF THE DRAWINGS

The accompanying drawings constituting a part of the present disclosure are used to provide a further understanding of the present disclosure. The exemplary embodiments of the present disclosure and descriptions thereof are used to explain the present disclosure, and do not constitute an improper limitation of the present disclosure.

FIG. 1 is a schematic flow chart of data preprocessing for abrupt change inspection involved in an implementation of the present disclosure.

FIG. 2 is a schematic flow chart of a spatial data abrupt change inspection process in national territory development planning involved in an implementation of the present disclosure.

FIG. 3 is a schematic flow chart of an encryption processing method of an abrupt change control attribute database involved in an implementation of the present disclosure.

FIG. 4 is a structural block diagram of a cloud client application system involved in an implementation of the present disclosure.

FIG. 5 is a structural block diagram of a cloud server application system involved in an implementation of the present disclosure.

FIG. 6 is a schematic flow chart of generation of an abrupt change control attribute database of an application system involved in an implementation of the present disclosure.

FIG. 7 is a schematic flow chart of abrupt change inspection and analysis of a to-be-compared spatial vector layer of an application system involved in an implementation of the present disclosure.

FIG. 8 is a structural block diagram of a cloud platform involved in an implementation of the present disclosure.

### DETAILED DESCRIPTION

The present disclosure is described in detail below with reference to the accompanying drawings. The description in the part is only exemplary and explanatory, and should not have any limiting effect on the protection scope of the present disclosure.

In addition, according to the description in the document, a person skilled in the art may make corresponding combinations of features in this embodiment in the document and in different embodiments.

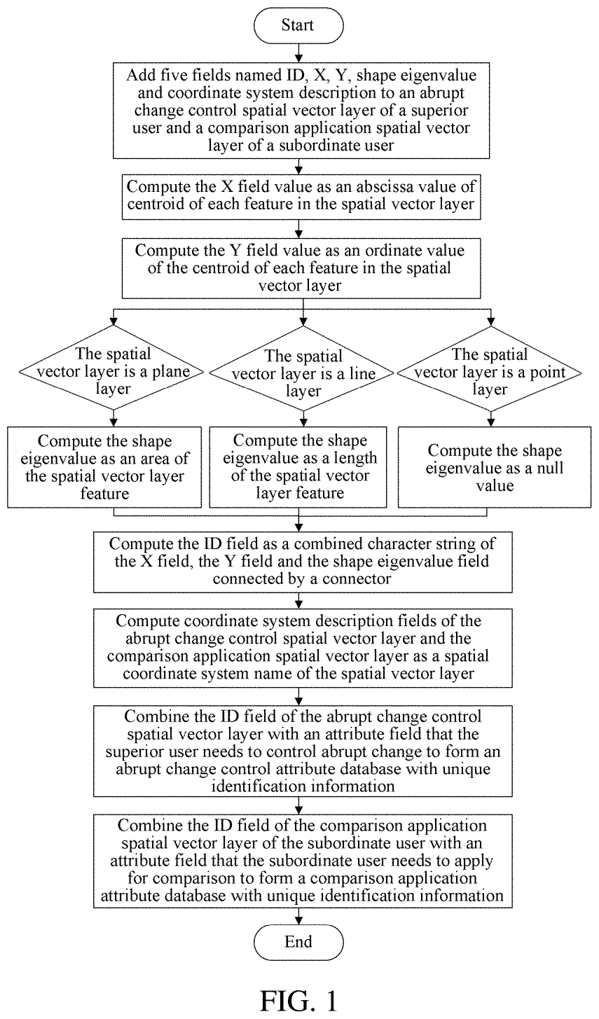

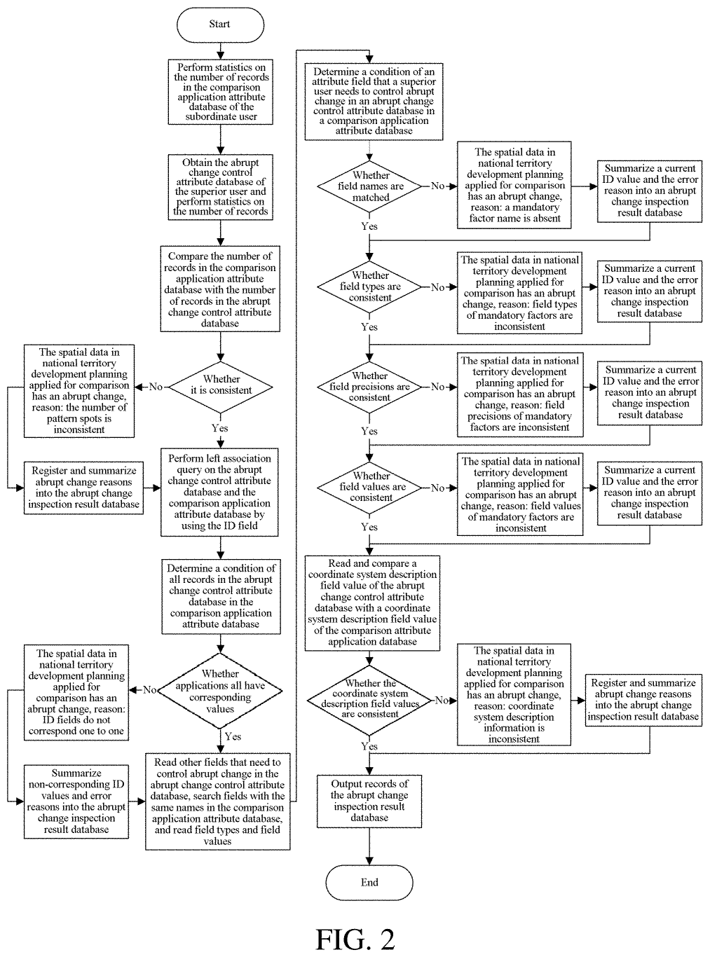

An embodiment of the present disclosure is as follows, referring to FIGS. 1-2, a spatial data abrupt change inspection method in national territory development planning includes the following steps:

(1) preprocessing of abrupt change inspection data: abrupt change control spatial data in national territory development planning of a superior user and to-be-compared spatial data in national territory development planning of a subordinate user are converted from a spatial vector layer to an attribute database with unique identification information:

(1.1) five fields named ID, X, Y, shape eigenvalue and coordinate system description are added to an abrupt change control spatial vector layer in spatial data in national territory development planning of the superior user and a to-be-compared spatial vector layer in spatial data in national territory development planning of the subordinate user respectively, where a field type of the ID field is text, field types of the X field and the Y field are integer, a field type of the shape eigenvalue field is double precision, and a field type of the coordinate system description field is text;

(1.2) the X field is computed as an abscissa value of centroid of each feature in the spatial vector layer with 2 decimal places reserved, the Y field is computed as an ordinate value of the centroid of each feature in the spatial vector layer with 2 decimal places reserved, the shape eigenvalue field is computed as a graphic related value of each feature in the spatial vector layer and the ID field is computed as a combined character string of the X field, the Y field and the shape eigenvalue field connected by a connector, where the ID field is the unique identification information; for example, X is 349087.34, Y is 35452784.98, the shape eigenvalue is 34.557875, the connector is “-”, then the ID field value is 349087.34-35452784.98-34.557875, and the ID field is the unique identification information for spatial data abrupt change inspection of the superior user and the subordinate user;

(1.3) coordinate system description fields of the abrupt change control spatial vector layer and the to-be-compared spatial vector layer are computed as a spatial coordinate system name of the spatial vector layer, such as a geographic coordinate system with the type of GCS_China_Geodetic_Coordinate_System_2000, or a projected coordinate system with the type of CGCS2000_3_Degree_GK_CM_99E;

(1.4) the ID field of the abrupt change control spatial vector layer is combined with an attribute field that the superior user needs to control abrupt change to form an abrupt change control attribute database with the unique identification information; and the ID field of the to-be-compared spatial vector layer of the subordinate user is combined with an attribute field that the subordinate user needs to request comparison to form a to-be-compared attribute database with the unique identification information; and

(2) abrupt change inspection: the abrupt change control attribute database and the to-be-compared attribute database are connected through the unique identification information, abrupt change records and abrupt change reasons are inspected through quantity statistics and attribute comparison, and are summarized into an abrupt change inspection result database, and the “record” in this embodiment is a “pattern spot”:

(2.1) statistics is performed on the number of records in the to-be-compared attribute database of the subordinate user;

(2.2) the abrupt change control attribute database of the superior user is obtained, statistics is performed on the number of records in the abrupt change control attribute database, the number of records in the to-be-compared attribute database is compared with the number of records in the abrupt change control attribute database, whether comparison results are consistent is determined, in response to determining that the comparison results are inconsistent, it is determined that the to-be-compared spatial data in national territory development planning of the subordinate user has an abrupt change, and the abrupt change reason is that “the number of pattern spots is inconsistent”, the abrupt change reason is registered and summarized into the abrupt change inspection result database; in response to determining that the comparison results are consistent, step (2.3) is performed;

(2.3) left association query is performed on the abrupt change control attribute database and the to-be-compared attribute database by using the unique identification information ID field:

for example, Select abrupt change control attribute database. ID, abrupt change control attribute database. X, abrupt change control attribute database. Y, . . . , to-be-compared attribute database. ID, to-be-compared attribute database. X, to-be-compared attribute database. Y, . . . from abrupt change control attribute database Left Join to-be-compared attribute database on abrupt change control attribute database. ID=to-be-compared attribute database. ID;

(2.3.1) whether all records in the abrupt change control attribute database have corresponding values in the to-be-compared attribute database is determined, in response to determining that all records do not have corresponding values, it is determined that the to-be-compared spatial data in national territory development planning has an abrupt change, the abrupt change reason is recorded as “the ID fields do not correspond one to one”, and non-corresponding ID values of the abrupt change control attribute database and error reasons are summarized into the abrupt change inspection result database;

(2.3.2) the attribute field that the superior user needs to control abrupt change in the abrupt change control attribute database is read, a field with the same name in the to-be-compared attribute database is searched, and the field type and the field value are read: whether the name of the attribute field that the superior user needs to control abrupt change in the abrupt change control attribute database is matched in the to-be-compared attribute database is determined, in response to determining that the name is not matched, it is determined that the to-be-compared spatial data in national territory development planning has an abrupt change, the abrupt change reason is recorded as “a mandatory field name is absent”, and current ID values of the to-be-compared attribute database and error reasons are summarized into the abrupt change inspection result database;

(2.3.3) whether the field type of the attribute field that the superior user needs to control abrupt change in the abrupt change control attribute database is consistent with the field type of the same name field in the to-be-compared attribute database is determined, in response to determining that the field types are inconsistent, it is determined that the to-be-compared spatial data in national territory development planning has an abrupt change, the abrupt change reason is recorded as “the mandatory factor field types are inconsistent”, and the current ID values of the to-be-compared attribute database and error reasons are summarized into the abrupt change inspection result database;

(2.3.4) whether the field precision of the attribute field that the superior user needs to control abrupt change in the abrupt change control attribute database is consistent with the field precision of the same name field in the to-be-compared attribute database is determined; in response to determining that the field precision is inconsistent, it is determined that the spatial data of the to-be-compared spatial vector layer in national territory development planning has an abrupt change, the abrupt change reason is recorded as “the mandatory factor field precision is inconsistent”, and the current ID values of the to-be-compared attribute database and error reasons are summarized into the abrupt change inspection result database;

(2.3.5) whether the field value of the attribute field that the superior user needs to control abrupt change in the abrupt change control attribute database is consistent with the field value of the same name field in the to-be-compared attribute database is determined; in response to determining that the field values are inconsistent, it is determined that the spatial data of the to-be-compared spatial vector layer in national territory development planning has an abrupt change, the abrupt change reason is recorded as “the mandatory factor field values are inconsistent”, and the current ID values of the to-be-compared attribute database and error reasons are summarized into the abrupt change inspection result database;

(2.4) a coordinate system description field value of the abrupt change control attribute database is read and compared with a coordinate system description field value of the to-be-compared attribute database, whether the coordinate system description field value of the to-be-compared attribute database is consistent with the coordinate system description field value in the abrupt change control attribute database is determined, in response to determining that the coordinate system description field values are inconsistent, it is determined that the to-be-compared spatial data in national territory development planning has an abrupt change, the abrupt change reason is recorded as “the coordinate system description information is inconsistent”, and the abrupt change reason is registered and summarized into the abrupt change inspection result database; and

(2.5) records of the abrupt change inspection result database are outputted, and the abrupt change inspection results is displayed to the subordinate user.

It needs to be noted that a feature in step 1.2 refers to a piece of information in the spatial vector layer, the information includes spatial information and attribute information, in addition, each spatial vector layer has a spatial coordinate system, and the spatial coordinate system is composed of a coordinate system name, a central longitude, a geographic coordinate system and the like; in step 1.3, the coordinate system name in the coordinate system is computed as a coordinate system description field for storage and for later comparison; and ID, X, Y, shape eigenvalue and coordinate system description fields added in step 1.4 are used for inspecting the changes of spatial data graphics, however, some attribute fields of the spatial data in national territory development planning also need to be controlled, which is determined by the specific situation. At this time, the attribute field that needs to control abrupt change is to be selected, and after the attribute field is selected together with the ID, X, Y, shape eigenvalue and coordinate system description fields, they jointly form an attribute database. A record in step 2.1 refers to a piece of information of the attribute database, which merely includes attribute information, does not include spatial information, so the record is different from the feature.

On the basis of the above embodiment, in another embodiment of the present disclosure, in step (1.2), types of the abrupt change control spatial vector layer and the to-be-compared spatial vector layer in the spatial data in national territory development planning are determined, in response to determining that the spatial vector layer is a plane layer, the shape eigenvalue field is computed as an area of a spatial vector layer feature, and the area reserves 4 decimal places; in response to determining that the spatial vector layer is a line layer, the shape eigenvalue field is computed as a length of the spatial vector layer feature, and the length reserves 4 decimal places; and in response to determining that the spatial vector layer is a point layer, the shape eigenvalue field is computed as a null value.

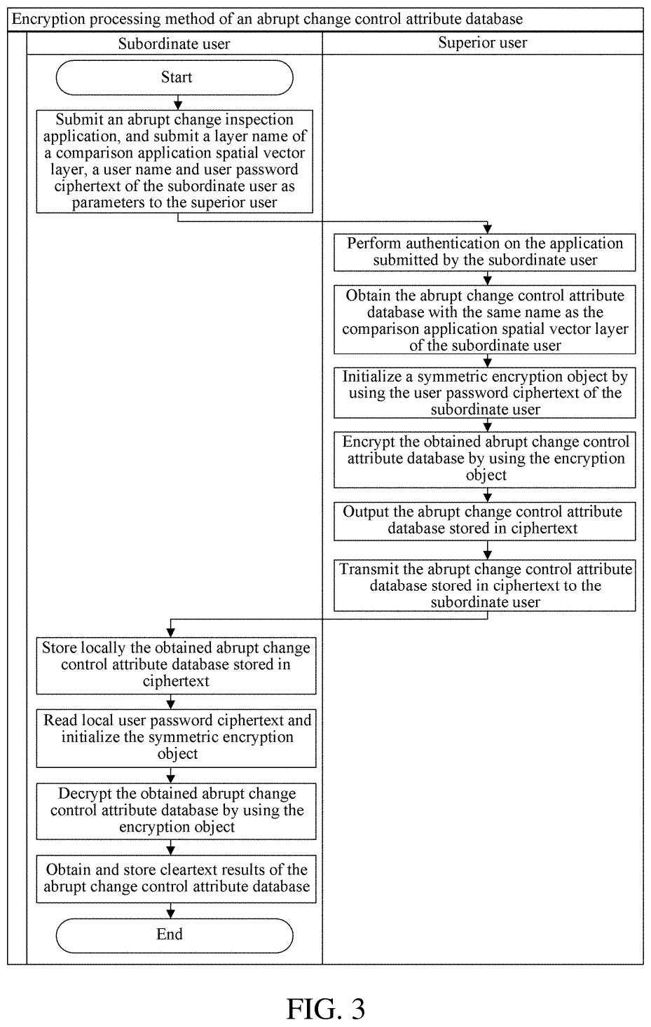

On the basis of the above embodiment, in another embodiment of the present disclosure, as shown in FIG. 3, between step (1) and step (2), the method further includes a step of encrypting the abrupt change control attribute database:

S1 an abrupt change inspection application is submitted by the subordinate user, and a layer name of the to-be-compared spatial vector layer, a user name and user password ciphertext of the subordinate user are submitted as parameters to the superior user;

S2 authentication is performed, by the superior user, on the application submitted by the subordinate user, the user name and the user password ciphertext submitted by the subordinate user are used for searching and comparing in a user system of the superior user, and in response to determining that the authentication fails, it is ended directly;

S3 after the authentication is passed, the abrupt change control attribute database with the same name as the to-be-compared spatial vector layer of the subordinate user is obtained, by the superior user, in the abrupt change control attribute database;

S4 a symmetric encryption object is initialized by the superior user using the user pas sword ciphertext of the subordinate user; here, a symmetric encryption algorithm is used for the encryption object, and the commonly used algorithms include DES, 3DES and the like;

S5 the obtained abrupt change control attribute database is encrypted by the superior user using the encryption object;

S6 the abrupt change control attribute database stored in ciphertext is outputted by the superior user;

S7 the abrupt change control attribute database stored in ciphertext is transmitted to the subordinate user by the superior user;

S8 the abrupt change control attribute database stored in ciphertext obtained from the superior user is stored locally by the subordinate user;

S9 the local user password ciphertext is read and the symmetric encryption object is initialized by the subordinate user, an algorithm used for the encryption object being the same as S4 at this time;

S10 the obtained abrupt change control attribute database is decrypted by using the encryption object; and

S11 cleartext results of the abrupt change control attribute database are obtained and stored.

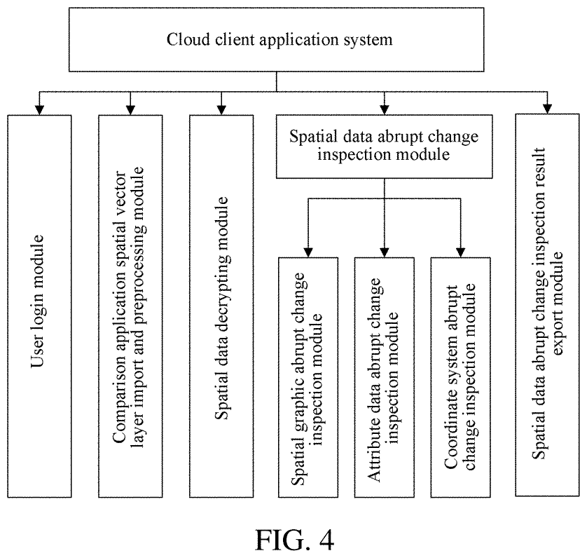

The present disclosure further provides an application system for spatial data abrupt change control in national territory development planning, the embodiments are as follows, the application system for spatial data abrupt change control in national territory development planning includes a cloud client application system and a cloud server application system. A structure of the cloud client application system is shown in FIG. 4, and includes: a user login module, configured to register and login the cloud client application system by a user; a to-be-compared spatial vector layer import and preprocessing module, configured to import a local to-be-compared spatial vector layer by the user according to a spatial data list that needs to be used according to requirements of national territory development planning, complete preprocessing of the imported data by using a step of data preprocessing for abrupt change inspection after the import, and give an error prompt for the absent spatial data that has not been imported; a spatial data decrypting module, configured to decrypt the abrupt change control attribute database stored in ciphertext obtained by application using user password ciphertext as a private key by using a step of encryption processing of the abrupt change control attribute database, obtain and store cleartext results of the abrupt change control attribute database; a spatial data abrupt change inspection module, configured to compare a to-be-compared attribute database with the obtained abrupt change control attribute database for spatial graphics, attribute factors and coordinate systems by using a step of spatial data abrupt change inspection in national territory development planning, and inspect whether a to-be-compared spatial vector layer has an abrupt change condition; and a spatial data abrupt change inspection result export module, configured to export abrupt change inspection results by the user.

The user can use the spatial data abrupt change inspection result export module to export the abrupt change inspection results as a result file in doc, xls, txt and other formats, so as to display the ID value, the error reasons and other information with abrupt change records in the to-be-compared attribute database to the user.

On the basis of the above embodiment, as shown in FIG. 4, the spatial data abrupt change inspection module includes: a spatial graphic abrupt change inspection module, configured to inspect problems that the number of pattern spots and the graphics are inconsistent; an attribute data abrupt change inspection module, configured to inspect problems that names, types, precision and attribute values of attribute fields are inconsistent; and a coordinate system abrupt change inspection module, configured to inspect a problem that coordinate system description information is inconsistent.

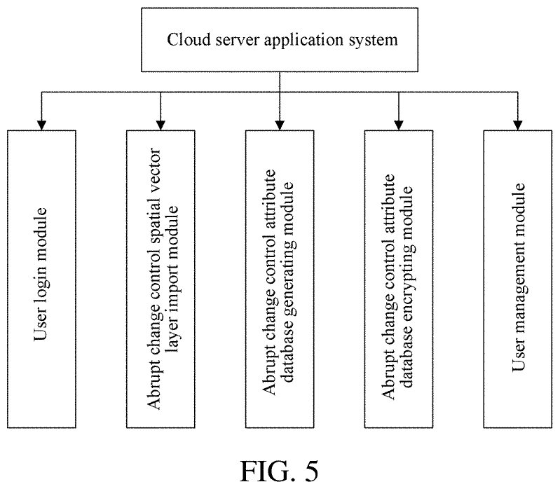

A structure of the cloud server application system is shown in FIG. 5, and includes: a user login module, configured to register and login the cloud server application system by the user; an abrupt change control spatial vector layer import module, configured to import a local abrupt change control spatial vector layer of the user by the user according to a spatial data list that needs to control abrupt change according to requirements of national territory development planning; an abrupt change control attribute database generating module, configured to select an abrupt change control spatial vector layer and attribute fields that needs to control abrupt change in each abrupt change control spatial vector layer by the user, complete preprocessing of the imported data by using a step of data preprocessing for abrupt change inspection, and generate an abrupt change control attribute database; an abrupt change control attribute database encrypting module, configured to symmetrically encrypt content of the abrupt change control attribute database by using obtained user password ciphertext of the subordinate user as a private key and using a step of encryption processing of the abrupt change control attribute database in a case that accessing and obtaining of the abrupt change control attribute database are accepted, encrypt the abrupt change control attribute database into the abrupt change control attribute database stored in ciphertext, and then transmit; and a user management module, configured to store and manage user information including user names and passwords of a cloud application system and the cloud server application system, where the user password is stored in a form of ciphertext.

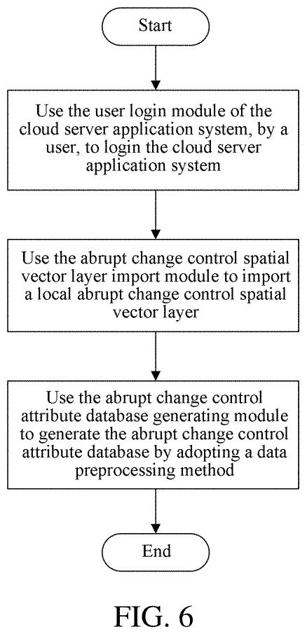

An application method and a process of the application system for spatial data abrupt change control in national territory development planning are divided into two steps: generation of the abrupt change control attribute database, and abrupt change inspection and analysis of the to-be-compared spatial vector layer. The generation process of the abrupt change control attribute database is shown in FIG. 6, and includes the following steps:

1. The user login module of the cloud server application system is used, by the user, to login the cloud server application system.

2. The abrupt change control spatial vector layer import module is used to import a local abrupt change control spatial vector layer.

3. The abrupt change control attribute database generating module is used to generate the abrupt change control attribute database by adopting a data preprocessing method.

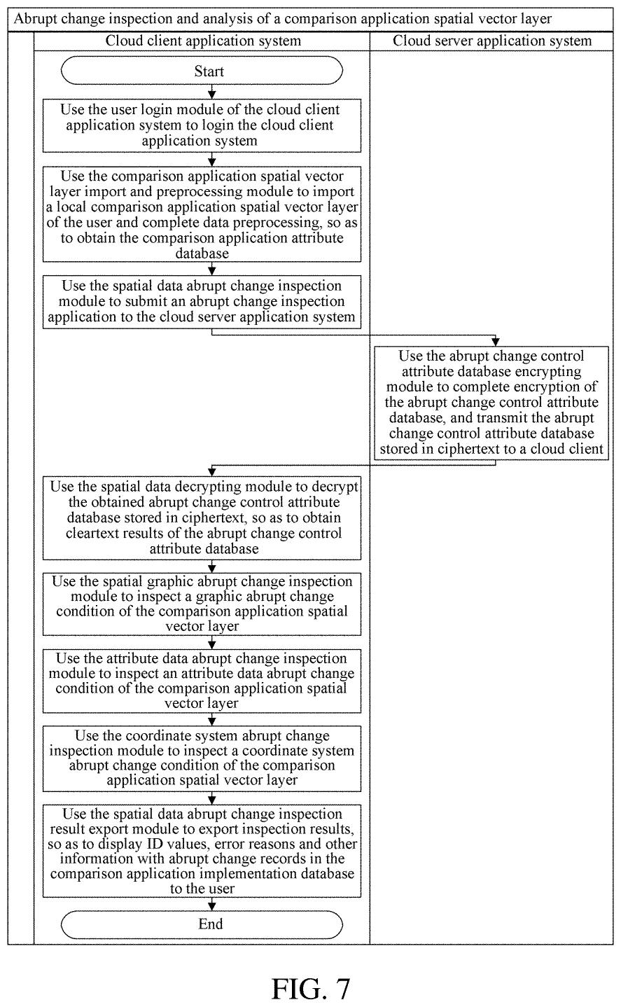

The abrupt change inspection and analysis process of the to-be-compared spatial vector layer is shown in FIG. 7, and includes the following steps:

1. The user login module of the cloud client application system is used, by the subordinate user, to login the cloud client application system.

2. The to-be-compared spatial vector layer import and preprocessing module of the cloud client application system is used, by the subordinate user, to import a local to-be-compared spatial vector layer of the user and complete data preprocessing, so as to obtain the to-be-compared attribute database.

3. The spatial data abrupt change inspection module is used, by the subordinate user, to submit an abrupt change inspection application to the cloud server application system.

4. A user name, a user password key, a to-be-compared spatial vector layer name and other parameters submitted by the cloud client system are obtained by the cloud server application system, the abrupt change control attribute database encrypting module is used to complete encryption of the abrupt change control attribute database, and the abrupt change control attribute database stored in ciphertext is transmitted to a cloud client.

5. After obtaining the data by the cloud client application system, the spatial data decrypting module of the cloud client application system is used, by the subordinate user, to decrypt the obtained abrupt change control attribute database stored in ciphertext, so as to obtain cleartext results of the abrupt change control attribute database.

6. The spatial graphic abrupt change inspection module of the cloud client application system is used, by the subordinate user, to inspect a graphic abrupt change condition of the to-be-compared spatial vector layer.

7. The attribute data abrupt change inspection module of the cloud client application system is used, by the subordinate user, to inspect an attribute data abrupt change condition of the to-be-compared spatial vector layer.

8. The coordinate system abrupt change inspection module of the cloud client application system is used, by the subordinate user, to inspect a coordinate system abrupt change condition of the to-be-compared spatial vector layer.

9. The spatial data abrupt change inspection result export module of the cloud client application system is used, by the subordinate user, to export inspection results, so as to display the ID value, the error reasons and other information with abrupt change records in the to-be-compared attribute database to the user.

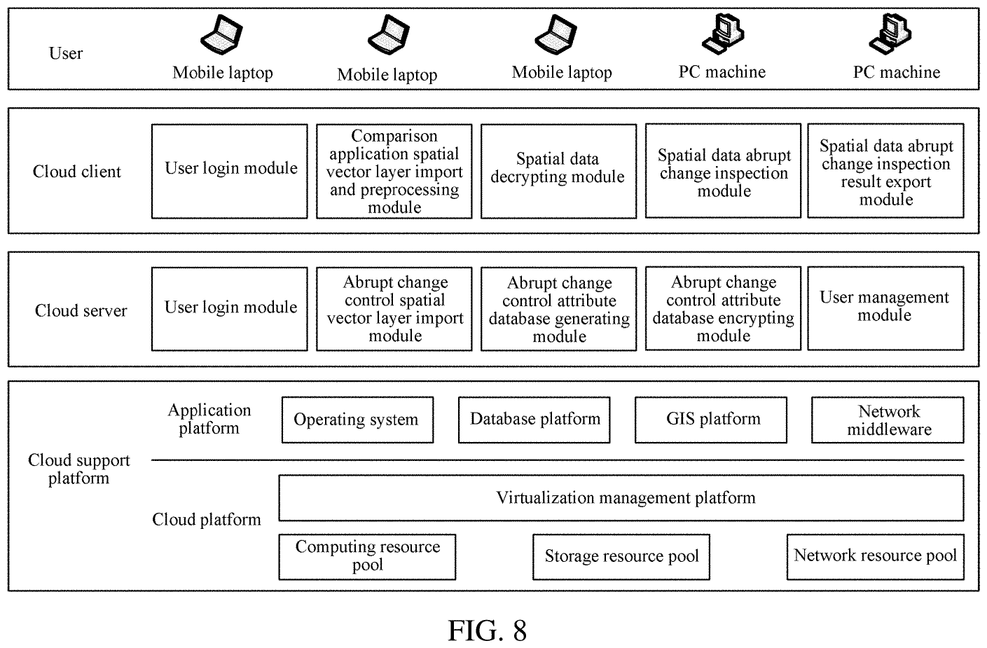

The present disclosure further provides a cloud platform system for spatial data abrupt change control in national territory development planning, the embodiments are as follows, as shown in FIG. 8, the cloud platform system is configured with any of the above application systems for spatial data abrupt change control in national territory development planning, and includes: a cloud client, configured with a cloud client application system; a cloud server, configured with a cloud server application system to provide a data comparison service for the cloud client application system; and a cloud support platform, configured to provide computing, storage, network communication and system operation capability supports for the cloud client application system and the cloud server application system.

On the basis of the above embodiment, in another embodiment of the present disclosure, as shown in FIG. 8, the cloud client includes but is not limited to computing and storage terminals such as a PC machine, a mobile laptop and a graphic workstation configured with the cloud client application system.

On the basis of the above embodiment, in another embodiment of the present disclosure, as shown in FIG. 8, the cloud support platform includes an X86 computing server for building a computing resource pool, a storage server for building a storage resource pool, a network server and gateway device for building a network resource pool, virtualization platform software for resource virtualization management, and one or more of application platforms that configure an operating system, a database platform, a GIS platform and network middleware on the platform.

The foregoing descriptions are exemplary implementations of the present disclosure. A person of ordinary skill in the art may make some improvements and modifications without departing from the principle of the present disclosure and the improvements and modifications shall fall within the protection scope of the present disclosure.

What is claimed is:

1. A spatial data abrupt change inspection method in national territory development planning, comprising the following steps:
(1) preprocessing of abrupt change inspection data: converting abrupt change control spatial data in national territory development planning of a superior user and to-be-compared spatial data in national territory development planning of a subordinate user from a spatial vector layer to an attribute database with unique identification information:
(1.1) adding five fields named ID, X, Y, shape eigenvalue and coordinate system description to an abrupt change control spatial vector layer in spatial data in national territory development planning of the superior user and a to-be-compared spatial vector layer in spatial data in national territory development planning of the subordinate user respectively, where a field type of the ID field is text, field types of the X field and the Y field are integer, a field type of the shape eigenvalue field is double precision, and a field type of the coordinate system description field is text;
(1.2) computing the X field as an abscissa value of centroid of each feature in the spatial vector layer, computing the Y field as an ordinate value of the centroid of each feature in the spatial vector layer, computing the shape eigenvalue field as a graphic related value of each feature in the spatial vector layer and computing the ID field as a combined character string of the X field, the Y field and the shape eigenvalue field connected by a connector, where the ID field is the unique identification information;
(1.3) computing coordinate system description fields of the abrupt change control spatial vector layer and the to-be-compared spatial vector layer as a spatial coordinate system name of the spatial vector layer;
(1.4) combining the ID field of the abrupt change control spatial vector layer with an attribute field that the superior user needs to control abrupt change to form an abrupt change control attribute database with the unique identification information; and combining the ID field of the to-be-compared spatial vector layer of the subordinate user with an attribute field that the subordinate user needs to request comparison to form a to-be-compared attribute database with the unique identification information; and
(2) abrupt change inspection: connecting the abrupt change control attribute database and the to-be-compared attribute database through the unique identification information, inspecting abrupt change records and abrupt change reasons through quantity statistics and attribute comparison, and summarizing into an abrupt change inspection result database:
(2.1) performing statistics on the number of records in the to-be-compared attribute database of the subordinate user;
(2.2) obtaining the abrupt change control attribute database of the superior user, performing statistics on the number of records in the abrupt change control attribute database, comparing the number of records in the to-be-compared attribute database with the number of records in the abrupt change control attribute database, determining whether comparison results are consistent, in response to determining that the comparison results are inconsistent, determining that the to-be-compared spatial data in national territory development planning of the subordinate user has an abrupt change, and the abrupt change reason is that “the number of pattern spots is inconsistent”, registering and summarizing the abrupt change reason into the abrupt change inspection result database; in response to determining that the comparison results are consistent, performing step (2.3);
(2.3) performing left association query on the abrupt change control attribute database and the to-be-compared attribute database by using the unique identification information ID field:
(2.3.1) determining whether all records in the abrupt change control attribute database have corresponding values in the to-be-compared attribute database, in response to determining that all records do not have corresponding values, determining that the to-be-compared spatial data in national territory development planning has an abrupt change, recording the abrupt change reason as “the ID fields do not correspond one to one”, and summarizing non-corresponding ID values of the abrupt change control attribute database and error reasons into the abrupt change inspection result database;
(2.3.2) reading the attribute field that the superior user needs to control abrupt change in the abrupt change control attribute database, searching a field with the same name in the to-be-compared attribute database, and reading the field type and the field value: determining whether the name of the attribute field that the superior user needs to control abrupt change in the abrupt change control attribute database is matched in the to-be-compared attribute database, in response to determining that the name is not matched, determining that the to-be-compared spatial data in national territory development planning has an abrupt change, recording the abrupt change reason as “a mandatory field name is absent”, and summarizing current ID values of the to-be-compared attribute database and error reasons into the abrupt change inspection result database;
(2.3.3) determining whether the field type of the attribute field that the superior user needs to control abrupt change in the abrupt change control attribute database is consistent with the field type of the same name field in the to-be-compared attribute database, in response to determining that the field types are inconsistent, determining that the to-be-compared spatial data in national territory development planning has an abrupt change, recording the abrupt change reason as “the mandatory factor field types are inconsistent”, and summarizing the current ID values of the to-be-compared attribute database and error reasons into the abrupt change inspection result database;
(2.3.4) determining whether the field precision of the attribute field that the superior user needs to control abrupt change in the abrupt change control attribute database is consistent with the field precision of the same name field in the to-be-compared attribute database; in response to determining that the field precision is inconsistent, determining that the spatial data of the to-be-compared spatial vector layer in national territory development planning has an abrupt change, recording the abrupt change reason as “the mandatory factor field precision is inconsistent”, and summarizing the current ID values of the to-be-compared attribute database and error reasons into the abrupt change inspection result database;
(2.3.5) determining whether the field value of the attribute field that the superior user needs to control abrupt change in the abrupt change control attribute database is consistent with the field value of the same name field in the to-be-compared attribute database; in response to determining that the field values are inconsistent, determining that the spatial data of the to-be-compared spatial vector layer in national territory development planning has an abrupt change, recording the abrupt change reason as “the mandatory factor field values are inconsistent”, and summarizing the current ID values of the to-be-compared attribute database and error reasons into the abrupt change inspection result database;
(2.4) reading and comparing a coordinate system description field value of the abrupt change control attribute database with a coordinate system description field value of the to-be-compared attribute database, determining whether the coordinate system description field value of the to-be-compared attribute database is consistent with the coordinate system description field value in the abrupt change control attribute database, in response to determining that the coordinate system description field values are inconsistent, determining that the to-be-compared spatial data in national territory development planning has an abrupt change, recording the abrupt change reason as “the coordinate system description information is inconsistent”, and registering and summarizing the abrupt change reason into the abrupt change inspection result database; and
(2.5) outputting records of the abrupt change inspection result database.

2. The spatial data abrupt change inspection method in national territory development planning according to claim 1, wherein in step (1.2), types of the abrupt change control spatial vector layer and the to-be-compared spatial vector layer in the spatial data in national territory development planning are determined, in response to determining that the spatial vector layer is a plane layer, the shape eigenvalue field is computed as an area of a spatial vector layer feature, in response to determining that the spatial vector layer is a line layer, the shape eigenvalue field is computed as a length of the spatial vector layer feature, and in response to determining that the spatial vector layer is a point layer, the shape eigenvalue field is computed as a null value.

3. The spatial data abrupt change inspection method in national territory development planning according to claim 1, wherein between step (1) and step (2), the method further comprises a step of encrypting the abrupt change control attribute database:
S1 submitting an abrupt change inspection application by the subordinate user, and submitting a layer name of the to-be-compared spatial vector layer, a user name and user password ciphertext of the subordinate user as parameters to the superior user;
S2 performing, by the superior user, authentication on the application submitted by the subordinate user, using the user name and the user password ciphertext submitted by the subordinate user for searching and comparing in a user system of the superior user, and in response to determining that the authentication fails, ending directly;
S3 after the authentication is passed, obtaining, by the superior user, the abrupt change control attribute database with the same name as the to-be-compared spatial vector layer of the subordinate user in the abrupt change control attribute database;
S4 initializing a symmetric encryption object by the superior user using the user password ciphertext of the subordinate user;
S5 encrypting the obtained abrupt change control attribute database by the superior user using the encryption object;
S6 outputting the abrupt change control attribute database stored in ciphertext by the superior user;
S7 transmitting the abrupt change control attribute database stored in ciphertext to the subordinate user by the superior user;
S8 storing locally the abrupt change control attribute database stored in ciphertext obtained from the superior user by the subordinate user;
S9 reading the local user password ciphertext and initializing the symmetric encryption object by the subordinate user, an algorithm used for the encryption object being the same as S4 at this time;
S10 decrypting the obtained abrupt change control attribute database by using the encryption object; and
S11 obtaining and storing cleartext results of the abrupt change control attribute database.

4. An application system, used for data processing by the spatial data abrupt change inspection method in national territory development planning according to claim 3, and comprising a cloud client application system and a cloud server application system, wherein the cloud client application system comprises:
a user login module, configured to register and login the cloud client application system by a user;
a to-be-compared spatial vector layer import and preprocessing module, configured to import a local to-be-compared spatial vector layer by the user according to a spatial data list that needs to be used according to requirements of national territory development planning, complete preprocessing of the imported data after the import, and give an error prompt for the absent spatial data that has not been imported;
a spatial data decrypting module, configured to decrypt the abrupt change control attribute database stored in ciphertext obtained by application using user password ciphertext as a private key, obtain and store cleartext results of the abrupt change control attribute database;
a spatial data abrupt change inspection module, configured to compare a to-be-compared attribute database with the obtained abrupt change control attribute database for spatial graphics, attribute factors and coordinate systems, and inspect whether a to-be-compared spatial vector layer has an abrupt change condition; and
a spatial data abrupt change inspection result export module, configured to export abrupt change inspection results by the user.

5. The application system according to claim 4, wherein the spatial data abrupt change inspection module comprises:
a spatial graphic abrupt change inspection module, configured to inspect problems that the number of pattern spots and the graphics are inconsistent;
an attribute data abrupt change inspection module, configured to inspect problems that names, types, precision and attribute values of attribute fields are inconsistent; and
a coordinate system abrupt change inspection module, configured to inspect a problem that coordinate system description information is inconsistent.

6. The application system according to claim 5, wherein the cloud server application system comprises:
a user login module, configured to register and login the cloud server application system by the user;
an abrupt change control spatial vector layer import module, configured to import a local abrupt change control spatial vector layer of the user by the user according to a spatial data list that needs to control abrupt change according to requirements of national territory development planning;
an abrupt change control attribute database generating module, configured to select an abrupt change control spatial vector layer and attribute fields that needs to control abrupt change in each abrupt change control spatial vector layer by the user, complete preprocessing of the imported data, and generate an abrupt change control attribute database;
an abrupt change control attribute database encrypting module, configured to symmetrically encrypt content of the abrupt change control attribute database by using obtained user password ciphertext of the subordinate user as a private key in a case that an application for accessing and obtaining the abrupt change control attribute database is accepted, encrypt the abrupt change control attribute database into the abrupt change control attribute database stored in ciphertext, and then transmit; and
a user management module, configured to store and manage user information comprising user names and passwords of a cloud application system and the cloud server application system, wherein the user password is stored in a form of ciphertext.

7. A cloud platform system, configured with the application system according to claim 4, and comprising:
a cloud client, configured with a cloud client application system;
a cloud server, configured with a cloud server application system to provide a data comparison service for the cloud client application system; and
a cloud support platform, configured to provide computing, storage, network communication and system operation capability supports for the cloud client application system and the cloud server application system.

8. The cloud platform system according to claim 7, wherein the cloud client comprises but is not limited to computing and storage terminals such as a PC machine, a mobile laptop and a graphic workstation configured with the cloud client application system.

9. The cloud platform system according to claim 7, wherein the cloud support platform comprises an X86 computing server for building a computing resource pool, a storage server for building a storage resource pool, a network server and gateway device for building a network resource pool, virtualization platform software for resource virtualization management, and one or more of application platforms that configure an operating system, a database platform, a GIS platform and network middleware on the platform.

10. A cloud platform system, configured with the application system according to claim 5, and comprising:
a cloud client, configured with a cloud client application system;
a cloud server, configured with a cloud server application system to provide a data comparison service for the cloud client application system; and
a cloud support platform, configured to provide computing, storage, network communication and system operation capability supports for the cloud client application system and the cloud server application system.

11. The cloud platform system according to claim 10, wherein the cloud client comprises but is not limited to computing and storage terminals such as a PC machine, a mobile laptop and a graphic workstation configured with the cloud client application system.

12. The cloud platform system according to claim 10, wherein the cloud support platform comprises an X86 computing server for building a computing resource pool, a storage server for building a storage resource pool, a network server and gateway device for building a network resource pool, virtualization platform software for resource virtualization management, and one or more of application platforms that configure an operating system, a database platform, a GIS platform and network middleware on the platform.

13. A cloud platform system, configured with the application system according to claim 6, and comprising:
a cloud client, configured with a cloud client application system;
a cloud server, configured with a cloud server application system to provide a data comparison service for the cloud client application system; and
a cloud support platform, configured to provide computing, storage, network communication and system operation capability supports for the cloud client application system and the cloud server application system.

14. The cloud platform system according to claim 13, wherein the cloud client comprises but is not limited to computing and storage terminals such as a PC machine, a mobile laptop and a graphic workstation configured with the cloud client application system.

15. The cloud platform system according to claim 13, wherein the cloud support platform comprises an X86 computing server for building a computing resource pool, a storage server for building a storage resource pool, a network server and gateway device for building a network resource pool, virtualization platform software for resource virtualization management, and one or more of application platforms that configure an operating system, a database platform, a GIS platform and network middleware on the platform.
